(19) United States
(12) Patent Application Publication
(10) Pub. No.: US 2009/0301442 A1
(43) Pub. Date: Dec. 10, 2009

(54) FUEL INJECTOR

(76) Inventor: Ferdinand Reiter, Markgroeningen (DE)

Correspondence Address: KENYON & KENYON LLP, ONE BROADWAY, NEW YORK, NY, 10004, US

(21) Appl. No.: 12/158,540

(22) PCT Filed: Nov. 8, 2006
(86) PCT No.: PCT/EP2006/068216

§ 371 Date: Oct. 29, 2008

(30) Foreign Application Priority Data
Dec. 22, 2005 (DE) 10 2005 061 424.8

(51) Int. Cl. F02M 51/00

(52) U.S. Cl. 123/490; 239/585.1

(57) ABSTRACT

A fuel injector, in particular for fuel injection systems of internal combustion engines. Such an injector is characterized by a magnetic circuit containing a core, a solenoid, an armature, and a movable valve needle having a valve closing body that cooperates with a fixed valve seat), the valve seat being formed on a valve seat body), and a valve seat carrier into which the valve seat body is introduced. The outer circumference of the valve seat body has a sawtooth-like structure for establishing a fixed connection to the valve seat carrier. The fuel injector is suitable in particular for use in fuel injection systems of mixture-compressing, externally ignited internal combustion engines.

### FIELD OF THE INVENTION

The present invention is directed to a fuel injector.

### BACKGROUND INFORMATION

FIG. 1 shows a fuel injector having a conventional three-part design of an internal metallic flow guide part and a housing component. This internal valve tube is formed by an inlet connecting piece forming an internal pole, a non-magnetic intermediate part, and a valve seat carrier accommodating a valve seat. An axially movable valve needle situated in the valve seat carrier includes an armature and a spherical valve closing body as well as a connecting tube that connects the armature to the valve closing body. The three individual components of the valve needle are fixedly joined together by an integral joining method, welding in particular.

German Patent No. DE 40 08 675 A1 describes such an electromagnetically operatable valve in the form of a fuel injector. The internal valve tube forms the basic skeleton of the entire injector and has an essential supporting function in its entirety for the three individual components. The non-magnetic intermediate part is fixedly and tightly connected to both the inlet connecting piece and to the valve seat carrier by welds. The windings of a solenoid are inserted into a plastic coil carrier, which in turn surrounds in the circumferential direction a part of the inlet connecting piece used as an internal pole and also surrounds the intermediate part. An axially movable valve needle situated in the valve seat carrier includes a sleeve-shaped armature and a spherical valve closing body as well as a connecting tube that connects the armature to the valve closing body. The connecting tube is fixedly attached by welds to both the armature and to the valve closing body. The valve closing body cooperates with a valve seat face of a metallic valve seat body in the form of a truncated cone. The valve seat body is fixedly attached to the valve seat carrier by a weld.

German Patent Application No. DE 195 03 224 A1 describes another electromagnetically operatable valve in the form of a fuel injector. The fuel injector has a spherical valve closing body cooperating with a valve seat, the valve closing body being mounted on a closing body carrier in the form of a plastic tube, while an armature is attached to the plastic tube at the end opposite the valve closing body. These components together form an axially movable valve needle. The lower end of the plastic tube is designed in the shape of a spherical cap and the valve closing body is positively secured in the convex recess with the aid of a snap-on connection. The plastic tube has a spring-elastic design in the area of the lower recess because holding jaws must enclose the valve closing body. The spherical valve closing body may be made of steel, ceramic, or plastic. The valve closing body cooperates with a valve seat face of a metallic valve seat body, the valve seat face being in the form of a truncated cone. The valve seat body is fixedly attached to the valve seat carrier by a weld.

### SUMMARY

An example fuel injector according to the present invention may have the advantage that simplified and cost-effective manufacturing and automatic assembly of the valve and the valve seat body in particular are implementable because integral joining methods such as welding, which have the disadvantage of thermal distortion, and complex positive joining methods may be omitted. Instead, particularly advantageous pressure bonds may be used between a metallic component partner and a nonmetallic component partner, which are applicable in a simple, very safe, and reliable manner. An example system according to the present invention also has the advantage of a reduction of the structure-borne noise and thus of noise generation compared to conventional approaches.

It may be advantageous in particular to secure the valve seat body in the valve seat carrier by pressing it in. The valve seat body is advantageously manufactured from a ceramic material to allow a reduction in the mass of the fuel injector. To further reduce the mass of the fuel injector, the valve seat carrier is made of a plastic. The reduced mass of these components results in the advantages of improved dynamics of the valve and reduced noise generation.

The plastic-ceramic compression joints may be manufactured to be particularly reliable and secure if the sawtooth-like structures in the overlap areas of the valve seat body and the valve seat carrier are designed in an optimized form. The sawtooth-like structure of the valve seat body as a ceramic component penetrates the plastic of the valve seat carrier and subsequently the plastic relaxes.

### BRIEF DESCRIPTION OF THE DRAWINGS

An exemplary embodiment of the present invention is illustrated in the figures in a simplified manner and explained in greater detail in the description below.

FIG. 1 shows a conventional fuel injector.

FIG. 2 shows an exemplary embodiment of a fuel injector according to the present invention.

FIG. 3 shows a valve seat body in an embodiment according to the present invention.

FIG. 4 shows a top view of the valve seat body according to FIG. 3.

### DETAILED DESCRIPTION OF EXAMPLE EMBODIMENTS

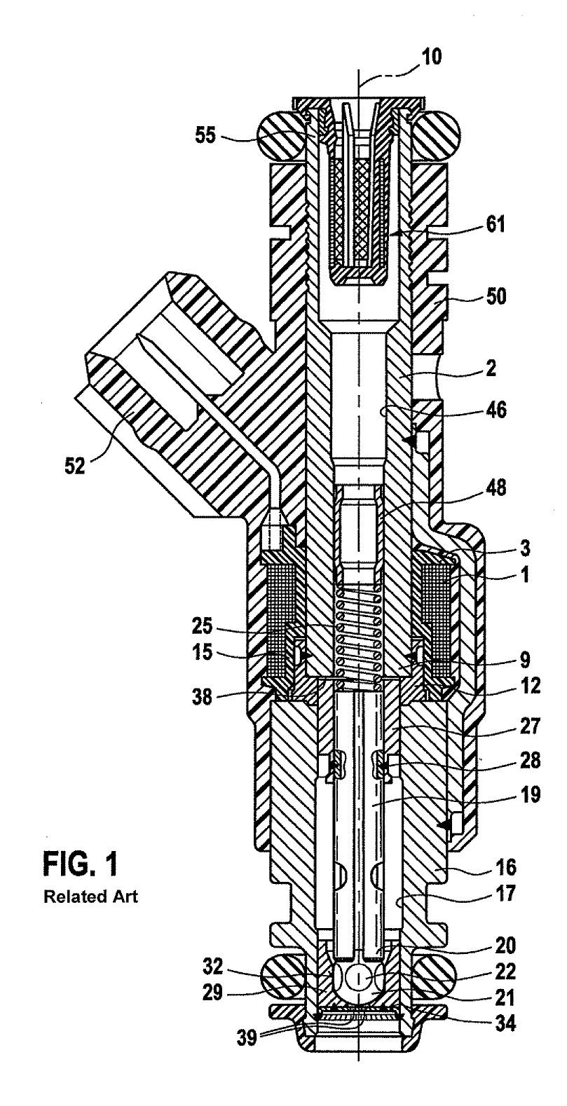

FIG. 1 shows a conventional fuel injector. The electromagnetically operatable valve in the form of an injector for fuel injection systems of mixture-compressing, externally ignited internal combustion engines, shown in FIG. 1 as an example, has a core 2, which is designed here in the form of a tube surrounded by a solenoid 1, has a constant external diameter over its entire length, and functions as the internal pole and fuel inlet connecting piece. A bobbin 3 having steps in the radial direction accommodates a winding of solenoid 1 and, in combination with core 2, allows a compact design of the injector in the area of solenoid 1.

A tubular metallic non-magnetic intermediate part 12 is attached tightly, e.g., by welding, to a lower core end 9 of core 2 in such a way that it is concentric with a longitudinal valve axis 10, and thereby partially surrounds core end 9 axially. Stepped bobbin 3 partially surrounds core 2 and, with a step 15 of a larger diameter, axially surrounds intermediate part 12 at least partially. Downstream from bobbin 3 and intermediate part 12, a tubular valve seat carrier 16 extends and is fixedly connected to intermediate part 12. A longitudinal borehole 17, which is designed to be concentric with longitudinal valve axis 10, runs in valve seat carrier 16. At its downstream end 20, a tubular valve needle 19 provided in longitudinal borehole 17 is attached by welding, for example, to a spherical valve closing body 21 on whose circumference five flattened areas 22, for example, are provided to allow the flow of fuel past it. Valve needle 19 represents the movable actuating part of the fuel injector.

The injector is operated electromagnetically in a known way. The electromagnetic circuit having solenoid 1, core 2, and an armature 27 functions to provide the axial movement of valve needle 19 and thus to open it against the spring force of a restoring spring 25 and/or to close the injector. Armature 27 is attached to the end of valve needle 19 facing away from valve closing body 21 by a weld 28 and is aligned with core 2. A cylindrical metallic valve seat body 29 having a fixed valve seat 30 is tightly installed by welding in longitudinal borehole 17 in the downstream end of valve seat carrier 16 facing away from core 2.

A guide opening 32 of valve seat body 29 acts to guide valve closing body 21 during the axial movement of valve needle 19 with armature 27 along longitudinal valve axis 10. Spherical valve closing body 21 cooperates with the valve seat of valve seat body 29, which tapers in the form of a truncated cone in the direction of flow. On its end facing away from valve closing body 21, valve seat body 29 is fixedly and concentrically connected to an injection hole disk 34 designed in the shape of a pot, for example. At least one, e.g., four spray opening(s) 39 shaped by erosion or punching, run(s) in the bottom part of injection hole disk 34.

The insertion depth of valve seat body 29 with pot-shaped injection hole disk 34 determines the preliminary setting of the lift of valve needle 19. One end position of valve needle 19 when solenoid 1 is not excited is determined by the contact of valve closing body 21 with the valve seat of valve seat body 29, while the other end position of valve needle 19 when solenoid 1 is excited is determined by the contact of armature 27 with core end 9.

An adjustment sleeve 48 inserted into a flow borehole 46 of core 2 running concentrically with longitudinal valve axis 10, the adjustment sleeve being shaped from rolled spring steel sheet, for example, functions as an adjustment of the spring pretension of restoring spring 25, which rests on adjustment sleeve 48 and is supported at its opposite end on valve needle 19. The injector is largely surrounded by a plastic sheathing 50. This plastic sheathing 50 includes, for example, an integrally molded electric plug connector 52. A fuel filter 61 protrudes into flow borehole 46 of core 2 at its inlet end 55 to filter out fuel constituents which might cause blockage or damage in the injector due to their size.

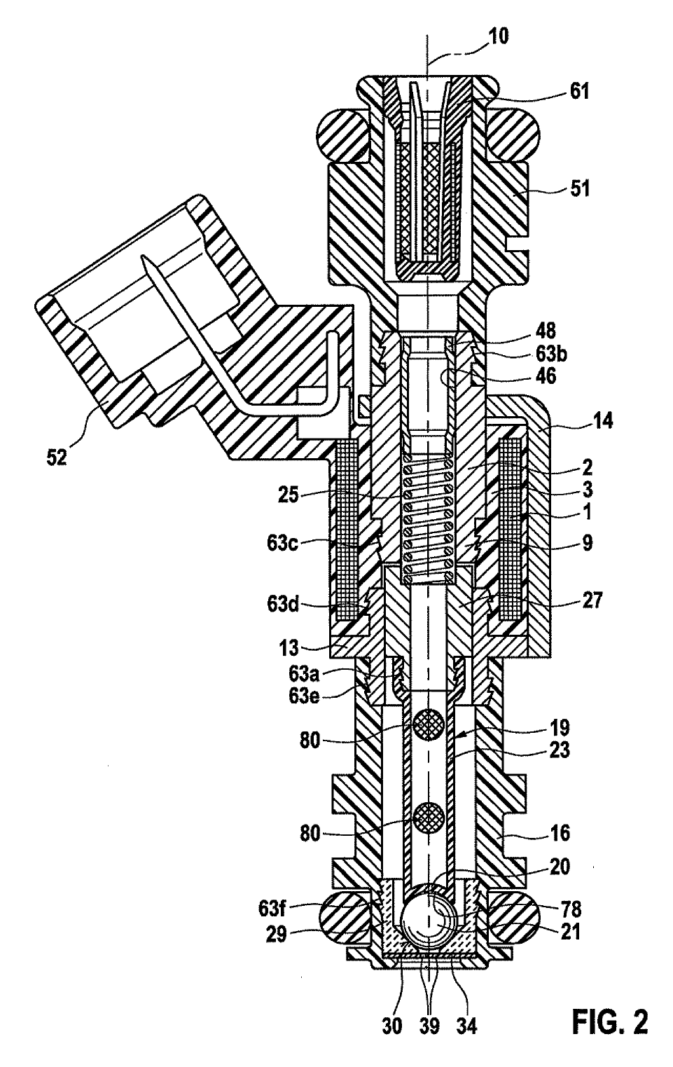

FIG. 2 shows an exemplary embodiment of a fuel injector according to the present invention. The fuel injector has a particularly simple and easy design. Several components of the fuel injector here are made of a plastic or a ceramic material, allowing a reduction in the mass of the fuel injector. With the conventional fuel injector according to FIG. 1, only plastic sheathing 50 together with plug connector 52 and bobbin 3 are made of plastic, but in the exemplary embodiment according to the present invention, valve seat carrier 16 and valve needle 19 are also components made of plastic, for example. It is therefore no longer possible to speak of a plastic sheathing of the fuel injector in the traditional sense because several of the components forming the valve housing are themselves manufactured directly from plastic. A connection 51 of plastic forms the intake channel of the fuel injector, for example, and accommodates fuel filter 61. Bobbin 3, for example, is designed in such a way that electric plug connector 52 protrudes from it in one piece.

valve needle 19 in the embodiment shown here is made of three individual components which together form the component, i.e., valve needle 19. Armature 27, which is designed as a rotating part, for example, forms a first individual component of valve needle 19, while a spherical valve closing body 21 forms a second individual component. A connecting tube 23 connecting armature 27 to valve closing body 21 constitutes a closing body carrier. Connecting tube 23 is manufactured by plastic injection molding, for example, and has an internal longitudinal opening from which a plurality of transverse openings emanates. The transverse openings may optionally be provided with a plastic or metallic mesh 80, which is applied as an insert during the injection molding of connecting tube 23.

On the lower end facing valve closing body 21, armature 27 has a sawtooth-like structure 63a having a “Christmas tree profile.” This structure 63a corresponds to an upper widened end of connecting tube 23 made of plastic. To produce a fixed connection between armature 27 and connecting tube 23, armature 27 is pressed with its structure 63a into connecting tube 23 in such a way that structure 63a is securely and reliably hooked and spread on the end of connecting tube 23 non-rotatably. To accommodate valve closing body 21, connecting tube 23 is provided with a curved, i.e., cup-shaped, recess 78. The curved receiving surface of recess 78 ideally has a slightly smaller diameter than the diameter of spherical valve closing body 21, so that after mounting valve closing body 21, a friction-locked connection is formed between connecting tube 23 and valve closing body 21 by applying a low contact force. Valve closing body 21 is securely, reliably, and reproducibly drawn out of valve seat 30 of valve seat body 29 via connecting tube 23 for applying electricity to solenoid 1, although valve closing body 21 is held “loosely” on connecting tube 23. A ceramic material, e.g., Si₃N₄, is recommended for valve closing body 21, which is designed as a solid sphere. However valve closing body 21 may also be made of a metallic, ceramic, or plastic.

To manufacture secure connections between fuel injector components made of metal and plastic, additional sawtooth-like structures 63 may be provided in a manner comparable to sawtooth-like structures 63a provided on armature 27 having a “Christmas tree profile.” For example, core 2 has sawtooth-like structures 63b, 63c on its two axial ends, to make sure that when core 2 is pressed into position, a secure and reliable fixed connection with connection 51 made of plastic as well as with bobbin 3 made of plastic is ensured. Two additional sawtooth-like structures 63d, 63e having a “Christmas tree profile” are provided on a magnetically conducting metallic intermediate part 13 situated beneath bobbin 3 in the axial extent of armature 27. This ring-shaped intermediate part 13 is designed with a T-shaped profile, for example, two legs of the T profile having structures 63d, 63e and thus ensuring a fixed secure connection to bobbin 3 and to valve seat carrier 16. The third leg of the T profile of intermediate part 13 extending radially outward is connected to a magnet pot 14, constituting an external magnetic component by which the magnetic circuit is closed.

According to the example embodiment of the present invention, the valve seat body 29 made of a ceramic material is inserted into the lower end of valve seat carrier 16 made of plastic. Ceramic material Si₃N₄ is recommended as the material for valve seat body 29. Such a material has only approximately ⅓ the mass of a component of a comparable size made of steel, which is generally used. Valve seat body 29 is also designed with a sawtooth-like structure 63f, which may be referred to as a “Christmas tree profile” on its outer circumference. To establish a fixed connection between valve seat body 29 and valve seat carrier 16, valve seat body 29 is pressed with its structure 63f into valve seat carrier 16 in such a way that structure 63f is hooked and spread fixedly, securely, and non-rotatably on the lower end of valve seat carrier 16. Sawtooth-like structure 63f of valve seat body 29, a ceramic component, thus penetrates into the plastic of valve seat carrier 16, and the plastic subsequently relaxes.

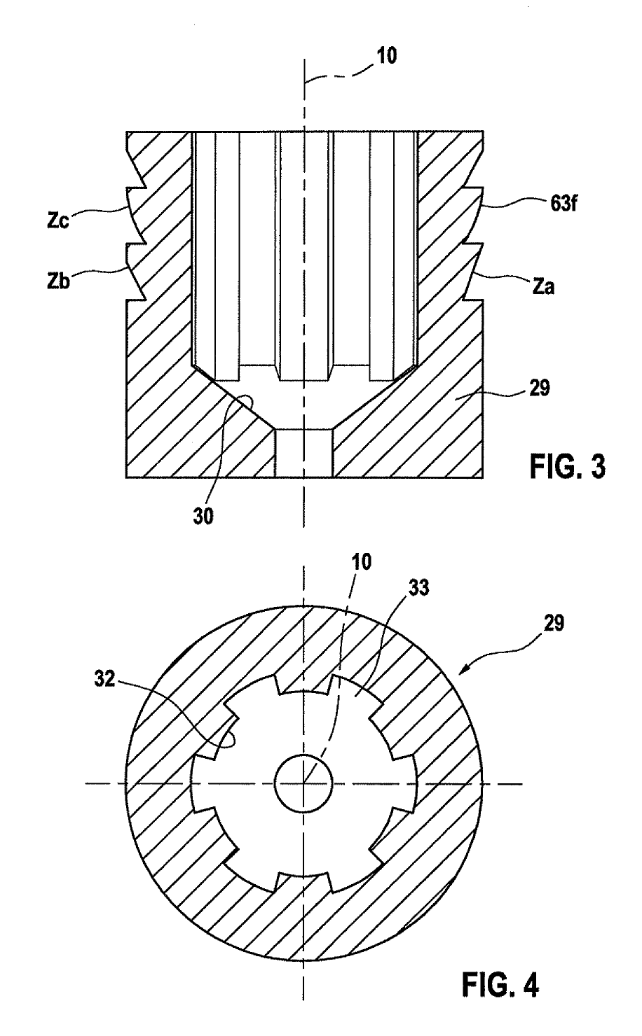

FIG. 3 shows a valve seat body 29 as a single component in an enlarged detail. Various possible embodiments of sawtooth-like structure 63f are shown together in FIG. 3. FIG. 3 shows that the sawtooth-like shape of structure 63f may be formed in such a way that it tapers directly to a point (Za), tapers obliquely and at a right angle with a kink (Zb), tapers with a curvature (Zc), or in combinations thereof.

FIG. 4 shows a top view of valve seat body 29 according to FIG. 3. It is clear from the top view that guide opening 32 for axially movable valve needle 19 may be interrupted several times by valve closing body 21. To this extent, guide opening 32 forms only individual guide sections designed to alternate at the circumference with flow grooves 33 having a larger diameter. Fuel may flow unhindered through flow grooves 33 in the direction of valve seat 30. It is also possible to provide only one flow groove 33.

The excitable actuator of the fuel injector as an electromagnetic circuit having solenoid 1, core 2, intermediate part 13, magnet pot 14, and armature 27 may also be designed as a piezoelectric or magnetostrictive drive, for example.

1-10. (canceled)

11. A fuel injector with a longitudinal valve axis for a fuel injection system of an internal combustion engine, comprising:
an excitable actuator;
a movable actuating part having a valve closing body cooperating with a fixed valve seat, the valve seat being molded on a valve seat body; and
a valve seat carrier into which the valve seat body is introduced, wherein the valve seat body has a sawtooth-like structure on an outer circumference to establish a fixed connection with the valve seat carrier.

12. The fuel injector as recited in claim 11, wherein the valve seat body is made of a ceramic material.

13. The fuel injector as recited in claim 12, wherein the ceramic material includes Si₃N₄.

14. The fuel injector as recited in claim 11, wherein the valve seat carrier is made of a plastic.

15. The fuel injector as recited in claim 11, wherein the valve seat body is adapted to be insertable into the valve seat carrier by pressing.

16. The fuel injector as recited in claim 11, wherein the sawtooth-like structure tapers at least one of directly to a point, obliquely and at a right angle with a kink, or with a curvature.

17. The fuel injector as recited in claim 11, wherein the valve seat body includes a guide opening for the valve closing body, the guide opening having at least one interruption as a flow groove.

18. The fuel injector as recited in claim 11, wherein the valve closing body is made of a metallic or ceramic material.

19. The fuel injector as recited in claim 11, further comprising:
a connecting tube as part of a valve needle, the connecting tube being a single component made of plastic, the connecting tube connecting an armature to the valve closing body.

20. The fuel injector as recited in claim 19, wherein the armature has a sawtooth-like structure and is pressed into the connecting tube to establish a fixed connection to the connecting tube.

21. The fuel injector as recited in claim 19, wherein the valve closing body is held loosely on the connecting tube of the valve needle without the use of an additive.
